(19) United States
(12) Patent Application Publication
(10) Pub. No.: US 2012/0130933 A1
(43) Pub. Date: May 24, 2012

(54) METHOD AND SYSTEM FOR SUPPORTING TO MAKE INVENTION

(75) Inventors: Itsuo Makino, Nomi-City (JP); Takaya Yuizono, Nomi-City (JP)

(73) Assignee: MAKINO KSAL COMPANY, LIMITED, Nomi-City (JP)

(21) Appl. No.: 12/951,720

(22) Filed: Nov. 22, 2010

(51) Int. Cl. G06N 5/02

(52) U.S. Cl. 706/46

(57) ABSTRACT

Method and system for making an invention are disclosed. Invention spaces are provided to support one to make pioneer-type or improvement inventions. An imaginary invention space is formed based on two circles disposed at both ends of an axis respectively. Each of the circles is determined by the number of indispensable constituent elements of inventions relating to a product. The method according to the invention comprises step for determining a first construction of a product having a plurality of indispensable elements, step for determining a second construction of a product having at least one element of the plurality of the indispensable elements, and step for determining a third construction of a product having the at least one element of the indispensable elements for the second construction and at least one new element not included in the plurality of indispensable elements.

### FIELD OF THE INVENTION

The invention relates to a method and a system for supporting to make an invention. It supports to discover a technological problem or to solve a problem to make pioneer-type or improvement inventions. The invention is applicable to a product, an apparatus and technology. But, the invention as applied to a product will be hereinafter explained.

### BACKGROUND OF THE INVENTION

It has been known Theory of Inventive Problem Solving (TRIZ) invented by G. S. Altshuller for solving technological problems to produce inventions. Good patented inventions were analyzed to know processes how the inventions had been made. A vast number of patents were analyzed to invent TRIZ. But, the patents were used to devise the methodology of TRIZ. TRIZ classifies problems to be solved into five layers. The first layer includes problems to be solved by using knowledge individuals own. The second layer includes problems to be solved by using knowledge organizations own. The third layer includes problems to be solved by using documents or information in the one industrial field. With the fourth layer of problems, knowledge in the other industrial field is used to produce a new concept to solve a problem. The fifth layer relates to develop a fundamentally new system. TRIZ is effective for the second, third and fourth layers of problems.

It has been known by some patent practitioners and examiners that the scope of a claim defining an invention is determined based on an embodiment of an invention and prior art. FIG. 1 shows a model diagram explaining how an invention has been protected and how an invention has been evaluated in the United States. A small blue circle k1 represents an embodiment of an invention. An outer red circle K1 represents the broadest scope of protection obtained by an inventor with respect to the prior art. It has also been known that a plurality of embodiments of an invention are covered with the outer red circle to support the broadest scope of protection. It has been known that an apparatus, for instance, defined in a claim as an invention comprises a plurality of indispensable elements, i.e., a combination of a plurality of elements.

TRIZ uses existing knowledge to solve a technological problem, and teaches ways to make inventions. But, discovering a problem and solving the problem to make inventions are separated from each other and are not directly connected therebetween.

With the invention protection model, it is understood that the scope of a claim is defined as an invention and determined based on an embodiment of the invention and with respect to prior art, and thus can be broadened up to the prior art or up to one or some inventions which relates to patentability of the new invention and had been known. While, the present invention starts with the construction of an apparatus or technology currently used, and goes back along a time axis to the one of the first apparatus having been put on the market and then consider technological developments in the future to make inventions. With the Kutani Porcelain produced in Ishikawa Prefecture in Japan, for instance, the invention starts with the construction of a current Kutani Porcelain product, and goes back to porcelain products in an era about four-hundred years ago.

Accordingly, the present invention provides a new method and system for making inventions. Attention is directed to the construction of an invention comprising indispensable constituent elements, a plurality of constructions of inventions, differences between constructions or changes found in the constructions.

### SUMMARY OF THE INVENTION

An object of the present invention is to provide a method and a system for supporting to make a pioneer-type or an improvement inventions and for making inventions.

One feature of the present invention is to provide a method for supporting to make an invention which comprises step for determining a first construction of a currently-used product having a plurality of indispensable elements, step for generalizing the first construction to determine a second construction of the firstly-developed product having a plurality of the indispensable elements, and step for determining a third construction of a product having at least one element of the indispensable elements for the second construction and at least one new element not included in the plurality of indispensable elements in the second construction of the firstly-developed product.

Another feature of the present invention is to provide a method for making an invention which comprises step for determining a first construction of a product having a plurality of indispensable elements, step for determining a second construction of a product having at least one element of the plurality of the indispensable elements, and step for determining a third construction of a product having the at least one element of the indispensable elements in the second construction and at least one new element not included in the plurality of indispensable elements.

Another feature of the present invention is to provide a method for assisting to make an invention which comprises step for determining a first construction of a product having indispensable elements, step for determining a second construction of a product having a lesser number of indispensable elements with respect to the one of the first construction, and step for determining a third construction of a product having indispensable elements the number of which being between the one of the first construction and the one of the second construction.

Another feature of the present invention is to provide a system for supporting to make an invention which comprises means for determining a first construction of a currently-used product having a plurality of indispensable elements, means for generalizing the first construction to determine a second construction of the firstly-developed product having a plurality of the indispensable elements, and means for determining a third construction of a product having at least one element of the indispensable elements for the second construction and at least one new element not included in the plurality of indispensable elements in the second construction of the firstly-developed product.

Another feature of the present invention is to provide a system for making an invention which comprises means for determining a first construction of a product having a plurality of indispensable elements, means for determining a second construction of a product having at least one element of the plurality of the indispensable elements, and means for determining a third construction of a product having the at least one element of the indispensable elements in the second construction and at least one new element not included in the plurality of indispensable elements.

### BRIEF DESCRIPTION OF THE DRAWINGS

FIG. 1 shows an invention protection or evaluation model applicable, particularly to patents issued in the United States;

FIG. 2 shows the principle of the present invention for making a pioneer-type invention;

FIG. 3 shows structuring invention knowledge;

FIG. 4 shows invention knowledge construction;

FIG. 5 shows the invention space part of FIG. 4; and

FIG. 6 shows a constructional arrangement of an embodiment according to the present invention.

### DETAILED DESCRIPTION OF THE INVENTION

FIG. 2 shows a diagram for explaining a method for making an invention. The generalized construction of, for instance, an apparatus is represented by a circle “V1” and is comprised with indispensable elements “A”, “B” and “C”. The circumference of the circle “V1” is determined by the number of elements “A”, “B” and “C”. The circle represented as “V1” is disposed on an axis on the left side as shown in FIG. 2. It is to be noted that an embodiment of an apparatus according to an invention (not shown) represented by “v1=a+b+c” is generalized to have “V1=A+B+C”. The construction represented by the circle “V1” is generalized to have a target construction of an apparatus represented by a circle “T” which is comprised with an indispensable element “A” of the generalized construction “V1”. The circle “T” is disposed on the axis on the right side as shown in FIG. 2. A cylindrical invention space is formed based on the circle “V1” and the circle “T”.

Referring to the construction of an apparatus “V1” having a combination of the elements “A”, “B” and “C” and the other construction of an apparatus “T” having the element “A”, there will be produced an embodiment of an invention represented by “v211=A+y11” by adding to the element “A” included in “V1” an element “y11”. When the embodiment of an invention “v211” is generalized, it will be an invention claimed as “V211”. One element “A” of the three elements “A”, “B” and “C” is combined with the element “y11” to have an embodiment of an invention represented by “v211”, with the element “y11” not included in the construction represented by “V1=A+B+C”. It is to be noted that in the same way, one of the elements of y12, y13, . . . y1n is added to the element “A” to have an embodiment of another invention. The element “y11” corresponds to the embodiment of an invention “v211”. The elements of “y12, y13, . . . y1n” correspond to embodiments of the inventions “v212, v213, . . . v21n” respectively. When the embodiments of the inventions represented as “v212, v213, . . . v21n” are generalized, they will be inventions defined as “V212, V213, . . . V21n” respectively. Each of the inventions “V211, V212, V213, . . . V21n” will be disposed in the cylindrical invention space and on the axis at a point thereof close to the circle represented as “v2”.

In the same way, the construction represented by the circle “V1” is generalized to have a target construction of an apparatus represented by a circle “T” which is comprised with an indispensable element “B” of the generalized construction “V1”. The circle “T” is disposed on the axis on the right side as shown in FIG. 2.

Referring to the construction of an apparatus “V1” having a combination of the elements “A”, “B” and “C” and the other construction of an apparatus “T” having the element “B”, there will be produced an embodiment of an invention represented by “v221=B+y21” by adding to the element “B” included in “V1” an element “y21”. When the embodiment of an invention “v221” is generalized, it will be an invention claimed as “V221”. One element “B” of the three elements “A”, “B” and “C” is combined with the element “y21” to have an embodiment of an invention represented by “v221”, with the element “y21” not included in the construction represented by “V1=A+B+C”. It is to be noted that in the same way, one of the elements of y22, y23, . . . y2n is added to the element “B” to have an embodiment of another invention. The element “y21” corresponds to the embodiment of an invention “v221”. The elements of “y22, y23, . . . y2n” correspond to embodiments of the inventions “v222, v223, . . . v22n” respectively. When the embodiments of the inventions represented as “v222, v223, . . . v22n” are generalized, they will be inventions defined as “V222, V223, . . . V22n” respectively. Each of the inventions “V221, V222, V223, . . . V22n” will be disposed in the invention space and on the axis at a point thereof close to the circle represented as “v2”.

In the same way, the construction represented by the circle “V1” is generalized to have a target construction of an apparatus represented by a circle “T” which is comprised with an indispensable element “C” of the generalized construction “V1”. The circle “T” is disposed on the axis as shown in FIG. 2.

Referring to the construction of an apparatus “V1” having a combination of the elements “A”, “B” and “C” and the other construction of an apparatus “T” having the element “C”, there will be produced an embodiment of an invention represented by “v231=C+y31” by adding to the element “C” included in “V1” an element “y31”. When the embodiment of an invention “v231” is generalized, it will be an invention claimed as “V231”. One element “C” of the three elements “A”, “B” and “C” is combined with the element “y31” to have an embodiment of an invention represented by “v231”, with the element “y31” not included in the construction represented by “V1=A+B+C”. It is to be noted that in the same way, one of the elements of y32, y33, . . . y3n is added to the element “C” to have an embodiment of another invention. The element “y31” corresponds to the embodiment of an invention “v231”. The elements of “y32, y33, . . . y3n” correspond to embodiments of the inventions “v232, v233, . . . v23n” respectively. When the embodiments of the inventions represented as “v232, v233, . . . v23n” are generalized, they will be inventions defined as “V232, V233, . . . V23n” respectively. Each of the inventions “V231, V232, V233, . . . V23n” will be disposed in the invention space and on the axis at a point thereof close to the circle represented as “v2”.

Further, the construction represented by the circle “V1” is generalized to have a target construction of an apparatus represented by a circle “T” which is comprised with indispensable elements “A” and “B” of the generalized construction “V1”. The circle “T” is disposed on the axis as shown in FIG. 2.

Referring to the construction of an apparatus “V1” having a combination of the elements “A”, “B” and “C” and the other construction of an apparatus “T” having the elements “A” and “B”, there will be produced an embodiment of an invention represented by “v311=A+B+x11” by adding to a combination of the elements “A+B” included in “V1” an element “x11”. When the embodiment of an invention “v311” is generalized, it will be an invention claimed as “V311”. A combination of the elements “A+B” of the three elements “A”, “B” and “C” is combined with the element “x11” to have an embodiment of an invention represented by “v311”, with the element “x11” not included in the construction represented by “V1=A+B+C”. It is to be noted that in the same way, one of the elements of x12, x13, . . . x1n is added to the combination of the elements “A+B” to have an embodiment of another invention. The element “x11” corresponds to the embodiment of an invention “v311”. The elements of “x12, x13, . . . x1n” correspond to embodiments of the inventions “v312, v313, . . . v31n” respectively. When the embodiments of the inventions represented as “v312, v313, . . . v31n” are generalized, they will be inventions defined as “V312, V313, . . . V31n” respectively. Each of the inventions “V311, V312, V313, . . . V31n” will be disposed in the invention space and on the axis at a point thereof close to the circle represented as “v3”.

In the same way, the construction represented by the circle “V1” is generalized to have a target construction of an apparatus represented by a circle “T” which is comprised with indispensable elements “A” and “C” of the generalized construction “V1”. The circle “T” is disposed on the axis as shown in FIG. 2.

Referring to the construction of an apparatus “V1” having a combination of the elements “A”, “B” and “C” and the other construction of an apparatus “T” having the elements “A” and “C”, there will be produced an embodiment of an invention represented by “v321=A+C+x21” by adding to a combination of the elements “A+C” included in “V1” an element “x21”. When the embodiment of an invention “v321” is generalized, it will be an invention claimed as “V321”. A combination of the elements “A+C” of the three elements “A”, “B” and “C” is combined with the element “x21” to have an embodiment of an invention represented by “v321”, with the element “x21” not included in the construction represented by “V1=A+B+C”. It is to be noted that in the same way, one of the elements of x22, x23, . . . x2n is added to the combination of the elements “A+C” to have an embodiment of another invention. The element “x21” corresponds to the embodiment of an invention “v321”. The elements of “x22, x23, . . . x2n” correspond to embodiments of the inventions “v322, v323, . . . v32n” respectively. When the embodiments of the inventions represented as “v322, v323, . . . v32n” are generalized, they will be inventions defined as “V322, V323, . . . V32n” respectively. Each of the inventions “V321, V322, V323, . . . V32n” will be disposed in the invention space and on the axis at a point thereof close to the circle represented as “v3”.

It is also possible to generalize the construction represented by the circle “V1” to have a target construction of an apparatus represented by a circle “T” which is comprised with indispensable elements “B” and “C” of the generalized construction “V1”. In the same manner as explained above, there are produced inventions “V331, V332, V333, . . . V33n” which are disposed in the invention space and on the axis at points thereof close to the circle represented as “v3” respectively.

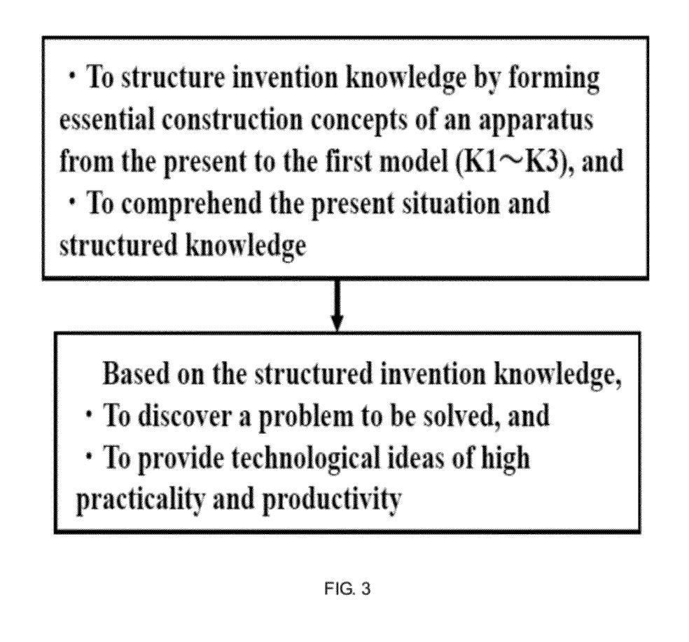

Referring to FIG. 3, flow diagram for the method and system according to the present invention will be explained. Essential construction concepts of an apparatus are selectively formed from the current apparatus up to the first model to structure invention knowledge. Based on the structured invention knowledge and other information, a technological problem will be discovered, which will lead one to make improvement or new-use inventions.

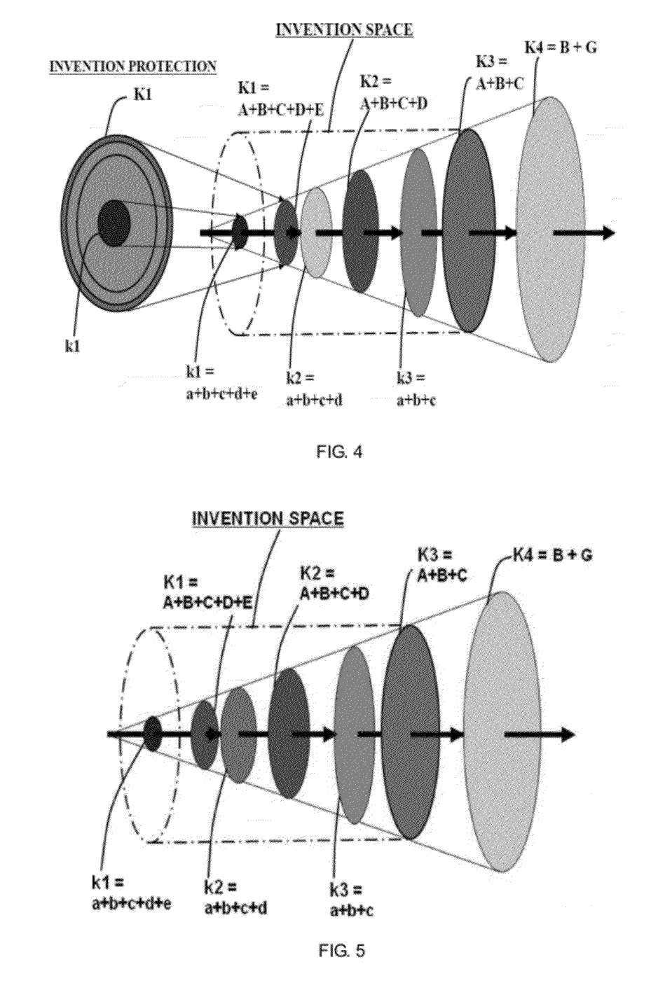

Referring to FIG. 4, four circles are provided as K1, K2, K3 and K4 showing generalized or abstracted conceptual constructions. The circumference of a first red circle K1 is determined by five indispensable constituent elements A, B, C, D and E for an apparatus currently used. The generalized conceptual construction K1, for instance, is obtained by generalizing the construction of an apparatus comprising constituent elements a, b, c, d and e (not shown). The circumference of a second green circle K2 is obtained by generalization and determined by four indispensable elements A, B, C and D for an apparatus manufactured at an older time instant.

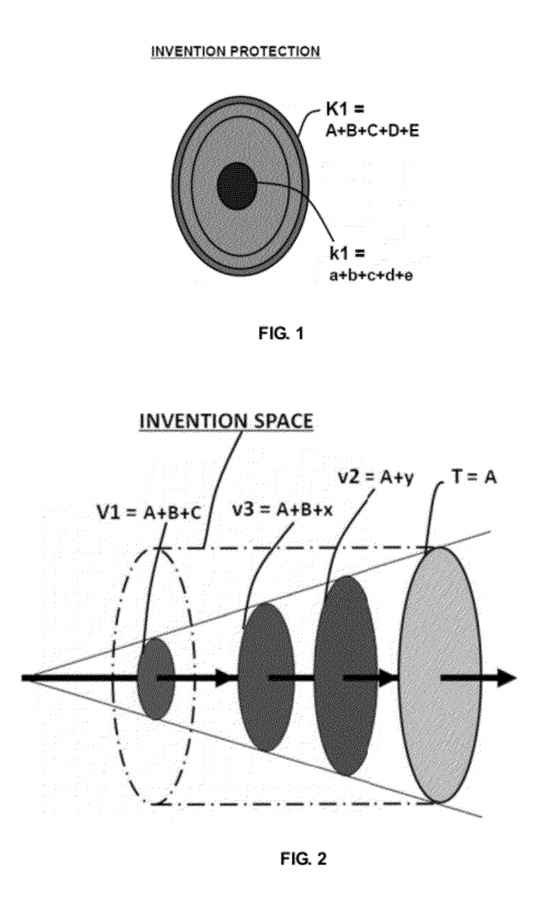

In the same way, the circumferences of a third purple circle K3 is obtained by generalization and determined by indispensable constituent elements A, B and C. The circumferences of a fourth yellow circle K4 is obtained by abstraction with respect to the circle K3 and determined by indispensable constituent elements B and G. It is to be noted that the outer red circle represented as “K1” shown in FIG. 1 is the same as the red circle represented as “K1” in FIG. 4. Thus, patent practitioners broaden the scope of a claim based on an embodiment of an invention up to the circumference of the red circle represented as “K1” or “k2” at most.

FIG. 5 shows the invention space part of FIG. 4. A three-dimensional invention space is made in a form of cylinder. The cylinder is determined by the circle K3 at the top, the circle k1 at the bottom and the circumference of the circle K3.

At first, the present construction of a product currently used is analyzed to determine indispensable elements thereof (k1), and then generalized to cover another example of product which functions in the same way as the present product (K1). The present construction of a product will be generalized also along a time axis up to the construction of the concept of the first product (K3) which was first put on the market. Between the present construction of a product (K1) and the construction of the product concept (K3), another generalization based on the present construction thereof is made at a time instant on the time axis (K2). In the same way, another generalization may be made along the time axis as required.

The three-dimensional invention space is formed by structuring invention knowledge. Within the imaginary cylinder, technological problems to be solved will be discovered and a method or an apparatus to solve it will be devised and thus, inventions will be made.

Experiment:

An experiment was conducted in the following way.
Subjects: Patent professionals, Members of Intellectual Property Subcommittee in Kansai Electronic Industry Development Center (KEC),
Reason: Accustomed to make documents requiring a combination of technological elements. But, not required to develop new technology or to make inventions,
Number of subjects: Eight persons,
Explanation about the experiment was made at KEC's meeting held in Nomi-City on Oct. 23, 2009, and
Experiments were made respectively at places the subjects like. Answers to questions were received to obtain experiment data.

An experiment was made on a vending machine with unwanted sound reducer to see the effectiveness of the proposed method relating to the present invention for structuring invention knowledge to produce technological ideas. We received from eight participants belonging to KEG experiment results and completed questionnaires.

Experiment Procedure:

Eight participants are divided into two groups. All of the eight participants are allowed to make searches to refer to any kinds of information and documents. The first group used the proposed method to produce ideas, while the second group produced technological ideas in their own ways without using the proposed method. Relevant assignments were conducted in companies the members of the second group belong to or in their homes.

To the First Group

We explained our proposed method to the first group for structuring invention knowledge to produce technological ideas. We presented the first group with an unexamined Japanese patent application publication No. 2009-237719 with its title “A feedback-type active sound reducer and vending machine” and the questionnaire. We asked the members of the first group to read the publication, and to make improvement or small inventions or any kinds of inventions to produce ideas to solve problems they may have or discover.

To the Second Group

We presented the second group with a letter explaining the experiment method and the unexamined patent application publication No. 2009-237719 and the questionnaire. We asked the members of the second group to read the publication, and to make improvement or small inventions or any kinds of inventions to produce ideas to solve problems they may have or discover.

The four participants of the first group described a plurality of essential construction concepts of a vending machine with unwanted sound reducer. As an example, the following shows a series of essential construction concepts formed by a participant of a vending machine with unwanted sound reducer. The four constructions of the series of essential construction concepts can be put respectively into cells forming a chart and displayed on the screen of an indicator.

Construction of Current Machine:

A vending machine with unwanted sound reducer comprising:
a compressor for adjusting temperature,
a microphone for detecting unwanted sounds,
a speaker for producing control sounds,
means for generating control sound signals to generate control sound signals,
detection means for detecting unwanted sounds above a predetermined level, and
a controller for controlling the means for generating control sound signals in response to an output from the detection means.

Construction Concept 1:

A vending machine with unwanted sound reducer comprising:
a compressor for adjusting temperature,
a microphone for detecting unwanted sounds,
a speaker for producing control sounds, and
means for generating control sound signals to generate control sound signals.

Construction Concept n:

An unwanted sound reducer comprising:
a microphone for detecting unwanted sounds,
a speaker for producing control sounds, and
means for generating control sound signals to generate control sound signals.

Abstraction:

An unwanted sound reducer for reducing unwanted sounds by using sounds having 180 degrees out of phase with respect to the unwanted sounds.

Ten technological ideas were presented by the four participants A, B, C and D in the first group. While, eighteen ideas were presented by the four participants E, F, G and H in the second group. Each idea is evaluated by the three evaluators with one of three, “F” having 5 points, “J” having 3 points and “K” having 1 point. For each idea presented, evaluation values given by the three evaluators are summed to be a total value in terms of six evaluation items as Originality, Practicality, Feasibility, Productivity, Inclusiveness and Insightfulness. It is to be noted that the evaluation items are taken from “Creative Cognition” by R. A. Finke et al.

Evaluation comparison between the first and second groups is made and its result is shown as Table 1 in the following.

There are shown average values of the ideas presented by the first group using the proposed method and by the second group producing their ideas in their own ways. A t-test is made on evaluation values.

As a result of the t-test and as seen in the Table 1, the ideas presented by the first group using the proposed method are more advantageous or preferable than the ones presented by the second group producing their ideas in their own ways in terms of five evaluation items as practicality, feasibility, productivity, inclusiveness and insightfulness.

TABLE 1
Idea Comparison between First and Second Groups

| Evaluation | Origi- | Practi- | Feasi- | Produc- | Inclu-* | Insight- |
|---|---|---|---|---|---|---|
| item | nality | cality* | bility* | tivity* | siveness | fulness* |
| First G. with | 9.8 | 13.0 | 11.8 | 12.4 | 12.2 | 12.2 |
| Proposed | | | | | | |
| Method | | | | | | |
| Second G. | 10.7 | 8.4 | 9.0 | 7.9 | 8.7 | 9.1 |
| without the | | | | | | |
| Method | | | | | | |

T-test:
*p < 0.05

With Table 1 for the first group using the proposed method and for the second group not using the method, it is thought that the first group structured invention knowledge to form the cylindrical invention space, and found relevant knowledge, information and technological problems in the invention space. It is thought that the invention space helped the participants of the first group to produce ideas of higher evaluation values in terms of evaluation items such as practicality and productivity. It is to be noted that eight technological ideas out of the ten ideas presented by the first group relates to vending machines with unwanted sound reducer. It is thought that these eight ideas are produced in the invention space determined by the plurality of the essential construction concepts formed.

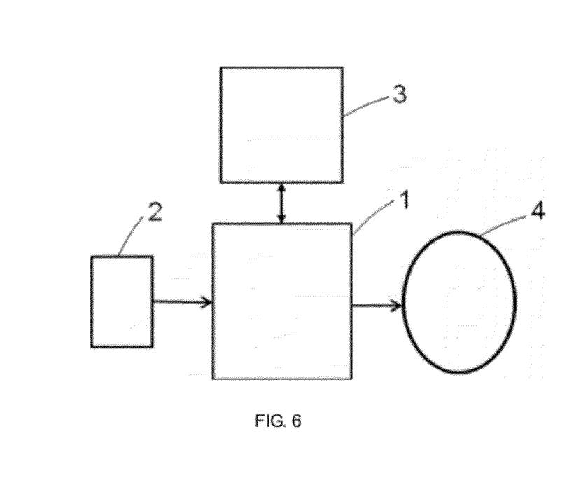

FIG. 6 shows a constructional arrangement of a system to assist one to make inventions, which is an embodiment of the present invention.

Referring to FIG. 6, a computer 1 is connected to an input device 2 and to a memory unit 3 and to a display device 4. The input device supplies the computer 1 with some kinds of data such as operational data for controlling the computer 1 or data for display or data to be maintained in the memory unit 3. The memory unit 3 stores data, texts, drawings, pictures and charts having essential construction concepts. The computer operates automatically in accordance with programs having been stored therein or in response to operational data received from the input device 2. The computer 1 processes data received from the input device 2 and from the memory unit 3 to provide the display device 4 with display signals. The display device 4 displays texts, pictures, drawings, the flow for structuring invention knowledge shown in FIG. 3, the invention spaces shown in FIG. 2, FIG. 4 and FIG. 5, an integrated invention space having the invention space shown in FIG. 2 and the invention space shown in FIG. 5 connected with each other, framework of the chart for describing construction of inventions or products, and the like. An operator interacts with the system so that desirous information can be displayed and seen. Further, it is also possible to describe essential construction concepts of a product in corresponding cells, which will lead the operator to discover problems or solve problems.

Although it has been explained that the invention space shown in FIG. 2 is used for making pioneer-type inventions and that the invention space shown in FIG. 4 and in FIG. 5 is used for making improvement inventions, it is possible to connect the invention space in FIG. 4 or FIG. 5 with the invention space shown in FIG. 2. When these two invention spaces are combined, the circle represented by “K3” in FIG. 4 and FIG. 5 will be the circle “V1” shown in FIG. 2. Knowledge and information obtained in exploring the invention space in FIG. 4 and FIG. 5 will be usefully used in making inventions in the invention space shown in FIG. 2. These knowledge and information will increase the number of problem discoveries and of means for solving problems.

Although the present invention has been particularly shown and described with reference to example embodiments of the invention, it will be understood by those skilled in the art that various changes in form and details may be made without departing from the scope of the invention encompassed by the appended claims.

What is claimed is:

1. Method for supporting to make an invention comprising:
step for determining a first construction of a currently-used product having a plurality of indispensable elements;
step for generalizing said first construction to determine a second construction of the firstly-developed product having a plurality of the indispensable elements; and
step for determining a third construction of a product having at least one element of the indispensable elements for the second construction and at least one new element not included in said plurality of indispensable elements in said second construction of the firstly-developed product.

2. Method for making an invention comprising:
step for determining a first construction of a product having a plurality of indispensable elements;
step for determining a second construction of a product having at least one element of the plurality of the indispensable elements; and
step for determining a third construction of a product having said at least one element of the indispensable elements in the second construction and at least one new element not included in said plurality of indispensable elements.

3. Method for assisting to make an invention comprising:
step for determining a first construction of a product having indispensable elements;
step for determining a second construction of a product having a lesser number of indispensable elements with respect to the one of the first construction; and
step for determining a third construction of a product having indispensable elements the number of which being between the one of the first construction and the one of the second construction.

4. System for supporting to make an invention comprising:
means for determining a first construction of a currently-used product having a plurality of indispensable elements;
means for generalizing said first construction to determine a second construction of the firstly-developed product having a plurality of the indispensable elements; and
means for determining a third construction of a product having at least one element of the indispensable elements for the second construction and at least one new element not included in said plurality of indispensable elements in said second construction of the firstly-developed product.

5. System for making an invention comprising:
means for determining a first construction of a product having a plurality of indispensable elements;
means for determining a second construction of a product having at least one element of the plurality of the indispensable elements; and
means for determining a third construction of a product having said at least one element of the indispensable elements in the second construction and at least one new element not included in said plurality of indispensable elements.
